(19) United States
(12) Patent Application Publication
(10) Pub. No.: US 2004/0002885 A1
(43) Pub. Date: Jan. 1, 2004

(54) System, methods and software implemented program product for managing an organization's resources

(76) Inventor: Scott Levy, Dallas, TX (US)

Correspondence Address: GODWIN GRUBER, P.C., RENAISSANCE TOWER, 1201 ELM STREET, SUITE 1700, DALLAS, TX, 75270, US

(21) Appl. No.: 10/375,478

(22) Filed: Feb. 27, 2003

Related U.S. Application Data
(60) Provisional application No. 60/360,369, filed on Feb. 27, 2002.

(51) Int. Cl. G06F 17/60

(52) U.S. Cl. 705/8

(57) ABSTRACT

A resource management application (60) allows an organization to focus its resources on outcomes that need to be achieved in order to complete one or more projects of a defined objective of the organization. With the present invention, every user (32, 34, 36) of the organization can understand how assigned outcomes on which a user is working contribute, effect, and fit within the organization's overall objectives. Moreover, with the present invention, collaboration between users provides a mechanism for assessing risks to projects resulting, for example, from delays in schedule, insufficient manpower, or unforeseen events. Notifications are automatically generated to a project manager (34) who can then research issues and decide if resolution of an issue creating a risk should be escalated to outcome status and, if so, assign resources to the outcome. Scheduling is automatically updated from the process of automatic collaboration such that all users working on a project are informed as to the status and progress of efforts toward an outcome.

### CROSS-REFERENCE TO RELATED APPLICATION

The application is related to Provisional Application Serial No. 60/360,369 entitled “COLLABORATIVE PROJECT OPTIMIZATION METHODS SYSTEM AND SOFTWARE,” by Scott Levy, filed Feb. 27, 2002, the entirety of which is incorporated herein by reference. This application claims priority of the aforementioned related provisional application

### TECHNICAL FIELD

The present invention relates to resource management applications and more particularly to the management of an organization's resources available to work on objective of the organization. More particularly, the invention relates to a system and related methodologies that allow an organization to focus on desired outcomes related to projects that must be completed in order to achieve organization objectives. Still more particularly, the invention provides a software implemented program product for allowing multiple users of an organization to collaborate with each other as they progress through specified outcomes related to defined projects of an organization.

### BACKGROUND OF THE INVENTION

Managing the collective efforts of groups of people presents many challenges in today's world. These challenges have resulted in the development of management techniques and systems which are now known as “modern project management.” Over the last thirty years, the power of the PC has been harnessed to manage a complexity of projects which such techniques and systems have likewise developed to allow the fine tuning and modification of plans. The result is an array of software products designed to manage everything from planning and construction of a factory in China to organizing the Olympic Games in Athens, or from plans for developing and launching a new global product to coordinating arrangements for a local party political conference.

Software tools to manage people, processes and projects have become increasingly complex. New features are typically welcome by seasoned project managers and technical executives. However, such prior art tools make it more difficult to learn to use by the nontechnical everyday users within the organization. This limitation applies even to market leading products such as Microsoft Project (Microsoft is a registered trademark of Microsoft Corporation) which is widely used but, dues to its complexity, may not be used by all users in an organization. At the opposite extreme from MS Project are products like Changepoint and Evolve (both of which are trademarks of their respective companies). Such professional service automation (PSA) solutions are used to control complete service center enterprises but are costly and complex to implement because they require substantial customization. Moreover, many PSA solutions require project management tools in order to deliver key project management functionality.

A particular disadvantage associated with prior art project management systems and PSAs is their inability to allow users throughout an organization to understand how they fit into the overall organization's mission and project objectives. Typically, such applications only provide for a scheduling of milestones that must be realized in order to complete a project. Yet no indication is given to the individual user as to how his or her efforts fit into a particular task and how his or her inability to achieve a task on time can affect others within the organization. Moreover, from the project management standpoint, a project manager has no readily accessible overview of the many users and user groups which may be working on a particular project, nor an indication of their progress or whether a delay may impact the project or put the project at risk. While sophisticated features of prior art project management systems and PSAs allow linking of task objectives and status indicators, such features are usually outside the grasp, ability or capability of the typical user who may not be well trained or versed in the use of such features. The relative complexity of such features may discourage its use across the organization and by users at the lowest level of a group or project responsibility.

Still another disadvantage of prior art project management systems and PSAs is the lack of overall integrated collaboration between users, both in common groups and in distant groups, of the organization. Simply, there is no readily available mechanism for allowing a project manager user to understand what skills are available throughout the organization and how to best utilize those skills for the most efficient management of organizational resources. From the standpoint of the project manager, this means that the assignments of organizational resources based on skill, availability, and other factors is inefficient process and largely a matter of guesswork and experience with people.

In short, the prior art project management systems fail to organized objectives of an organization according to desired outcomes. Moreover, prior art systems do not allow the lowest level user to understand how his or her efforts contribute to or affect the objectives of the organization.

As such, there is a need for a tool that would allow an organization to define objectives, projects to achieve those objectives, and outcomes associated with a project that allows users of an organization to work on discernable outcomes. Moreover, a tool that would allow a project manager to monitor the status and progress of efforts toward specified outcomes through user collaboration and outcome scheduling would provide numerous advantages.

### SUMMARY OF THE INVENTION

The present invention provides a tool, in the form of a system, associated methodologies, and a software implement program product, that allows an organization to focus its resources on outcomes that need to be achieved in order to complete one or more projects of a defined objective of the organization. With the present invention, every user (employee, project manager, executive) of the organization can know the status of outcomes related to projects and understand how such outcomes contribute, effect, and fit within the organization's overall objectives. Moreover, with the present invention, collaboration between users provides a mechanism for assessing risks to projects resulting, for example, from delays in schedule, insufficient manpower, or unforeseen events. Notifications are automatically generated to a project manager who can then research issues and decide if an issue should be escalated to an outcome and, if so, assign resources for working on the outcome. Scheduling is automatically updated through collaboration such that all users working on a project are informed as to the status and progress of efforts toward an outcome and its effect on associated outcomes and projects.

Accordingly, the present invention discloses a system for managing an organization's resources available to work on a specific objective of the organization with the resources including users arranged into one or more groups and hierarchy designating at least one project manager. The system is adapted to manage resources according to specified projects that must be completed in order to achieve an objective of the organization. The system comprises a plurality of user terminals available for use by users of the organization and a resource management application accessible by the users via the user terminal. According to one embodiment, the resource management application comprises a database for storing projects relating to a specific objective, the outcomes necessary to support these projects and available resources of the organization for working on these projects. The resource management application also includes a plurality of individual group and project management functions operatively coupled to the database and a communications function adapted to facilitate interactions between the individual group and project management functions and users of the terminals.

The system also comprises a network coupling user terminals to the resource management application wherein the resource management application further comprises collaborative and scheduling processing logic that allows users to be associated with one or more groups which support an objective which, in turn, supports projects of the organization. The collaborative and scheduling processing logic further allows users to communicate with each other the status of specific outcomes assigned to them for achieving the projects. The collaborative and scheduling processing logic further allows a project manager to determine the progress of efforts toward an outcome and to modify the schedule associated with the outcome based on its progress.

Also disclosed is a method for managing an organization's resources available to work on an objective of an organization, the resources including users arranged into one or more groups and a hierarchy designating at least one project manager from among the users. The method comprises the steps of organizing an objective of the organization into a plurality of projects and a plurality of outcomes necessary to achieve the projects. Next, the resources of the organization are associated with the plurality of outcomes and an exchange of information on a collaborative basis is performed regarding the status and/or progress of efforts toward outcomes which must be achieved to complete the projects.

The method can also comprise the step of scheduling one or more users to work on a specific outcome based on the amount of time which the one or more users have available. If so, scheduling deadlines are specified for completion of the outcomes and the progress is reported by the users toward the completion of the outcome. The method can also comprise the step of the users and project managers communicating on a collaborative basis with one another.

Also disclosed is a software implanted program product for use on a computer network that facilitates the management of an organization's resources available to work on a specific objective of the organization. The resources include users arranged into one or more groups and a hierarchy with at least one user acting as a project manager. The program product comprises a database for storing one or more projects related to the objective and the outcomes necessary to support said projects and available resources of the organization. The product also includes a plurality of individual group and project functions operatively coupled to the database with communications functions for facilitating interaction between the individual group and project functions and the users by access to the database. The program product also includes collaborative and scheduling processing logic for allowing users associated with one or more groups which support the projects to communicate with each other on a collaborative basis so that users working on a project will be informed as to the status of specific outcomes assigned to them to achieve projects associated with the objective. In one embodiment, the collaborative and scheduling processing logic also allows project manager to determine the status of an outcome and to modify the schedule associated with any particular outcome based on its status.

A specific advantage of the invention is that users (those working for a company, for example) of an organization maintain focus on particular outcomes that relate to specific projects.

Another specific advantage of the present invention is that users can view how their activities relate to other projects and therefore to an objective of the organization. When an outcome is behind schedule, for example, users associated with the outcome can see how it affects the overall progress of projects. In this way, a particular user can readily determine how his or her efforts contribute to the objectives of the organization.

Still another specific embodiment of the invention is that issues and risks can be dealt with on a collaborative basis through communications between users assigned to particular outcomes and project managers. As such, the resolution of a particular risk can be elevated to outcome status and users assigned to work on the outcome toward its resolution.

Yet still another advantage of the present invention is that organization resources can be viewed and assigned to outcomes resulting in efficient use of people available work times and skills.

### BRIEF DESCRIPTION OF THE DRAWINGS

Specific embodiment of the invention, including its advantages, will be understood by reference to the following detailed descriptions taken in conjunction with the appended drawing in which:

FIG. 1 is a diagram of a system for managing an organization's resources available to work on a specific objective of the organization according to the invention;

FIG. 2 is shown a simplified block diagram of a network wherein the system for managing an organization's resources according to the invention can be implemented;

FIGS. 3a-3h illustrate a database structure suitable for use with a resource management application according to the invention.;

FIG. 4 is a block diagram illustrating individual functions;

FIG. 5 is a block diagram illustrating the functions relative to an individual's availability;

FIG. 6 is a block diagram illustrating a plurality of group functions;

FIG. 7 is a block diagram illustrating that project functions can include a designation of key outcomes necessary for the achievement of a given project;

FIG. 8 shows a breakdown of outcomes and users involved with particular projects;

FIG. 9 is a process flow diagram for the methodology of setting up an organization for using a resource management application;

FIGS. 10a, 10b, and 10c illustrate utilization of a resource management application by a typical user according to the invention; and

FIG. 11 illustrates utilization of a resource management application by a project manager according to the invention

References in the detailed description refer to like references in the figures unless otherwise indicated.

### DETAILED DESCRIPTION OF THE PREFERRED EMBODIMENTS

Throughout the descriptions below, the following terms may and will be used in accordance with the following definitions:

| Database Term | Term Name | Description |
|---|---|---|
| Actor | Actor | A person who uses the resource management |
| | | application, and Human Resources are stored in |
| | | the Actors table. |
| Code Tables | Type | Tables used to normalize relationship and core |
| | | tables. |
| EffortType | | |
| CustomFieldType | | |
| DateFormat | | |
| DayOfweek | | |
| EffortType | | |
| EmailType | | |
| HelpIndex | | |
| IssueType | | |
| ItemType | | |
| LicenseType | | |
| OutcomeType | | |
| OutcomeFlagReason | | |
| PhoneType | | |
| ProjectType | | |
| ScheduleType | | |
| Status | | |
| Document | Supporting | Documents or Universal Resource Locators |
| | Materials | (URLs) to materials used to support a project. |
| Issue record with Type value that | Issue | Information which should be addressed in the |
| corresponds to “Issue” | | course of a project by project managers or |
| | | others. |
| Issue record with Type value that | Risk | Information description factors which place a |
| corresponds to “Risk” | | project at risk. |
| Mission | Group or | A collection of outcomes used together as |
| | Organization | mission to guide a group or an entire |
| | Mission | Organization. |
| | Statement | |
| Mission | Mission | A group of outcomes that together describe a |
| | | project or group's reason for existing; a project |
| | | mission may consist of key outcomes; the |
| | | individual outcomes that make up a mission are |
| | | referred to as mission items; mission items are |
| | | open ended- they do not have time limits as they |
| | | indicate a general direction. |
| Objective | Strategic | An outcome that represents significant, |
| | Objective | tangible/measurable progress toward realizing |
| | | mission; strategic objectives generally have a |
| | | time limit; a strategic objective can be viewed as |
| | | an outcome that is specifically related only to |
| | | group or a group mission item. |
| Outcome | Outcome | An outcome is a planned result. |
| | | The dictionary definition of outcome: |
| | | “an end result; a consequence.” |
| | | Note: The idea of outcome is to distinguish a |
| | | paradigm of proactive goal setting and |
| | | organization from the small and much less |
| | | powerful class of applications known as “task |
| | | management” or “activity management”. Both |
| | | activities and tasks can be encompassed in the |
| | | term outcome, which is the driver of the activity |
| | | that results in the planned outcome being |
| | | realized |
| Outcome record with Outcome Type | Milestone | A result (the outcome) that is used to gauge |
| value that corresponds to “Milestone” | | progress toward achieving the key outcomes of a |
| | | project. |
| Outcome record with | Action Based | Outcomes that result from immediately preceding |
| pkOutcomeType value | Outcomes | specific activities: Action Item, phone call, |
| corresponding to activity type | | meeting, user defined, specific action |
| Outcome with pkOutcomeType that | Deliverable | Outcomes which produce tangible items such as |
| corresponds to “Deliverable” | | documentation, screen shots prototypes, etc. |
| OutcomeEffort | Activity | Specific action taken to realize an outcome. |
| ProjectObjective | Key Outcomes | The purpose for organizing a project or |
| | | temporary team; Mission items for something that |
| | | exists for limited period of time; see mission |
| ProjectPersonal | Personal Project | A project of either personal nature or a project |
| | | which serves an individual's professional goals. |
| ProjectScene | Project | A group of related outcomes that together |
| | | achieve a common purpose and/or set of key |
| | | outcomes. |
| ProjectScene record with | Scenario | Snapshot of all attributes for a specific project or |
| pkProjectType value that | | group of projects that are or could be active |
| corresponds to “Scenario” | | Scenario has a cause and effect . . . allows you to |
| | | see the cause and effect of modifying a project, |
| | | the cause being a change in project. |
| ProjectScene record with | Active Project | A project which is currently in progress. |
| pkProjectType value that | | |
| corresponds to “Active” | | |
| ProjectScene record with | Draft Project | A project plan which may or may not be activated |
| pkProjectType value that | | in the future, but is currently in preliminary stages |
| corresponds to “Draft” | | of planning or otherwise incomplete. |
| ProjectScene record with the | Scheduled | An active project plan scheduled to being started |
| pkProjectType value that | Project | at a specific date in the future. |
| corresponds to “Active” | | |
| ProjectStatus record with pkStatus | Closed Project | A project for which all work has been completed. |
| value that corresponds to | | |
| ‘Completed’ | | |
| Scene | Super Project | A project which contains other projects as |
| | (a.k.a. - Scene) | components. Also, a snapshot of all projects that |
| | | are or could be active for the Organization. |
| Unit | Group | A number of people and/or other resources |
| | | working together for a common goal. |
| Unit | Organizational | A group that reflects an Organization's defined |
| | Unit | organizational structure. |

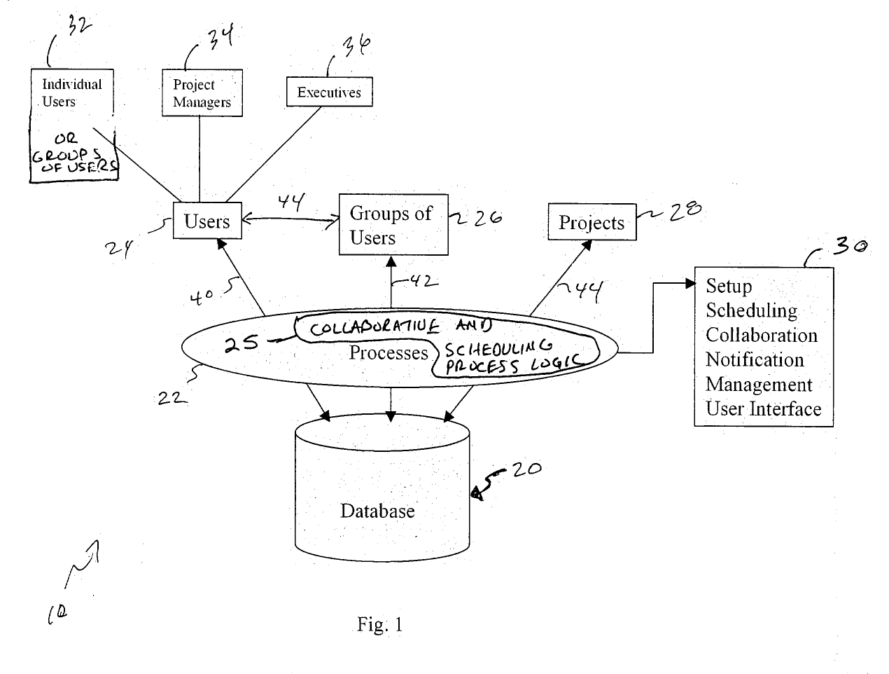

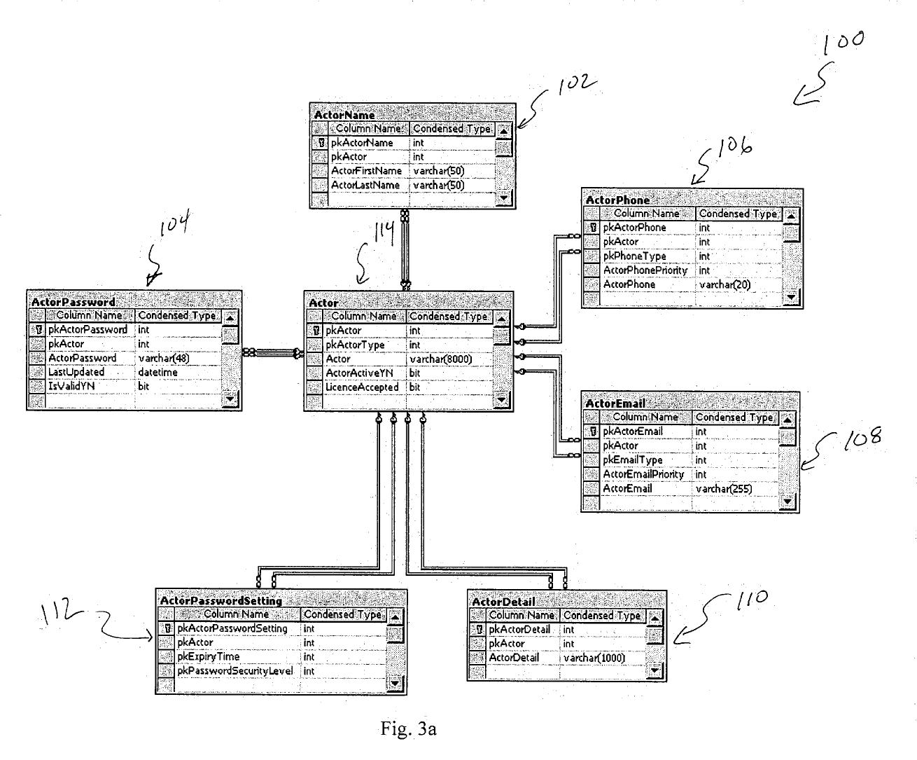

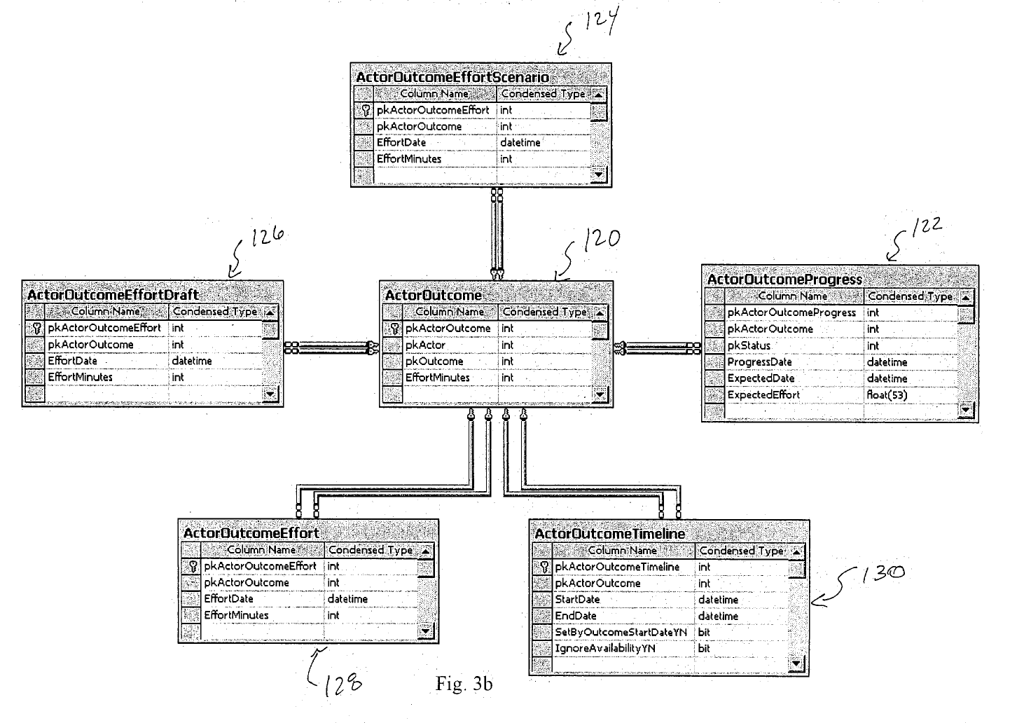

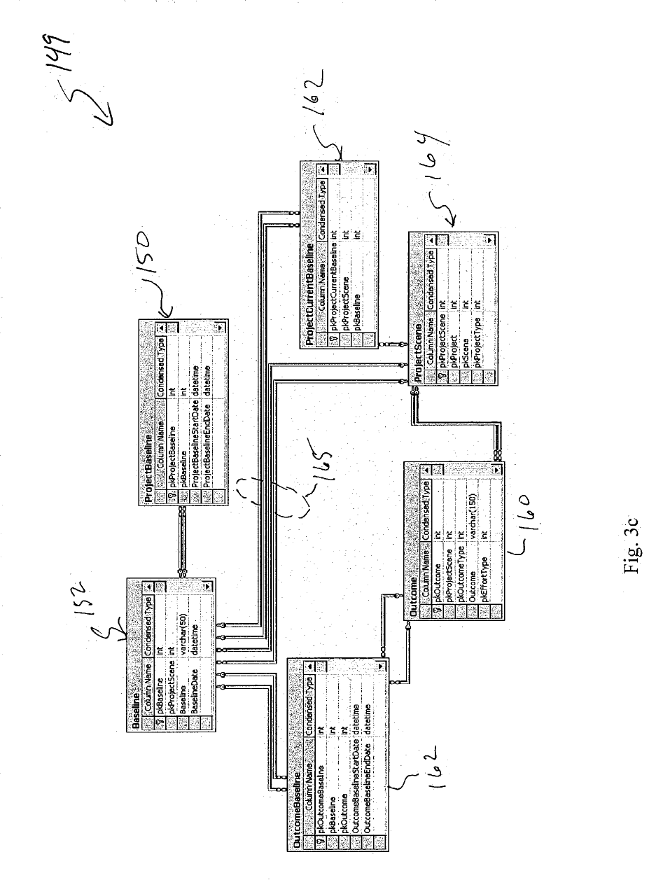

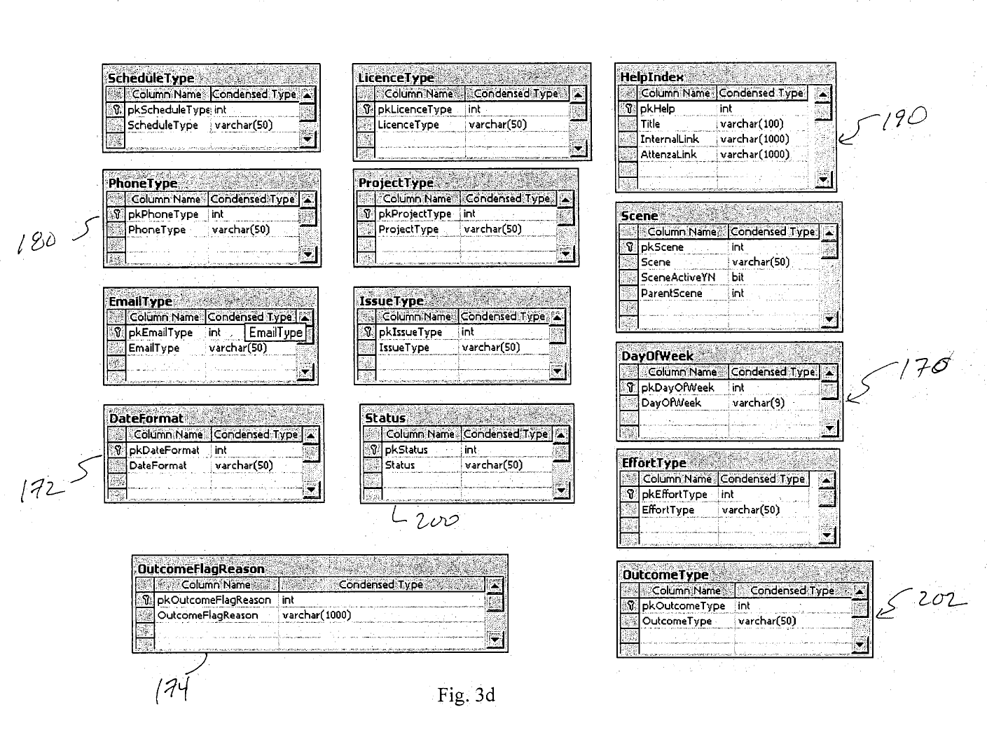

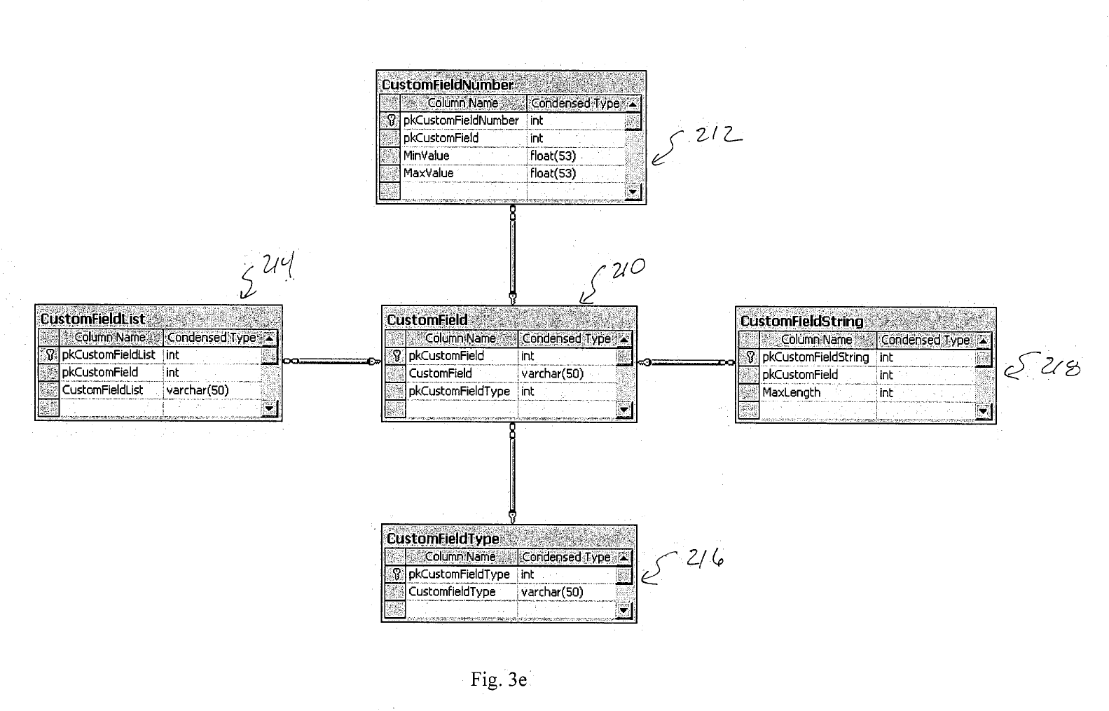

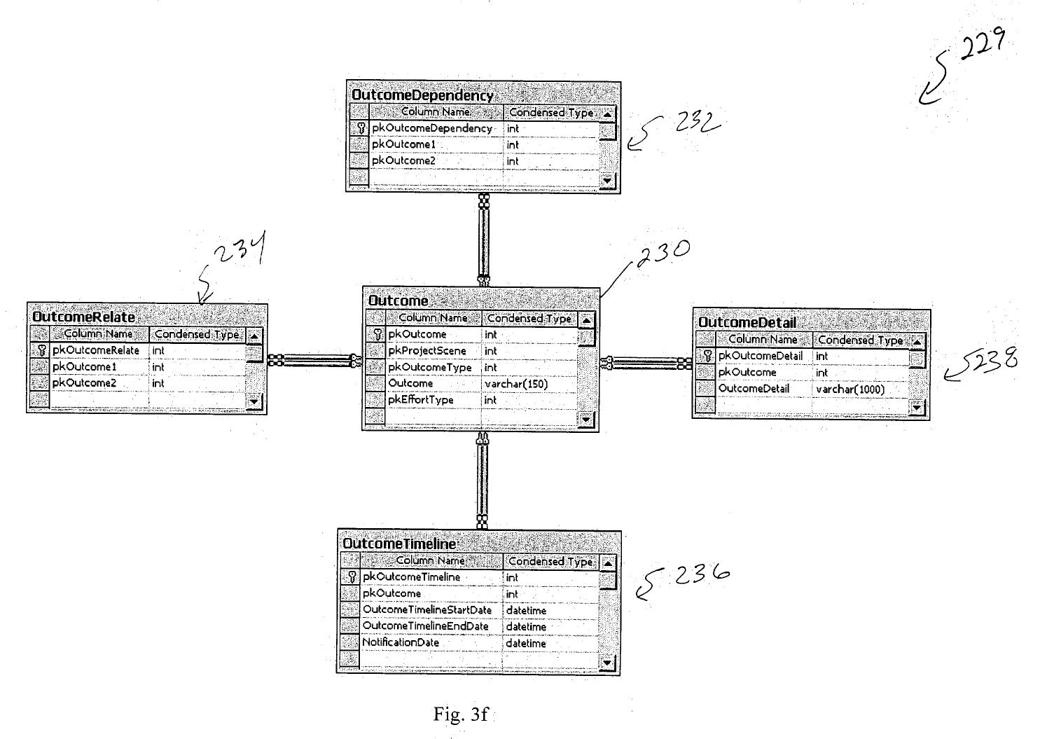

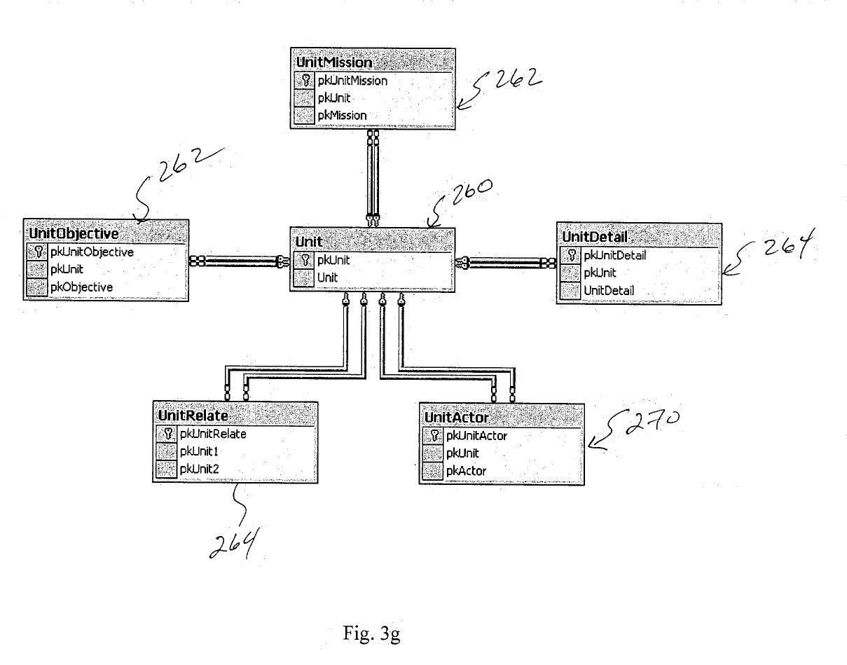

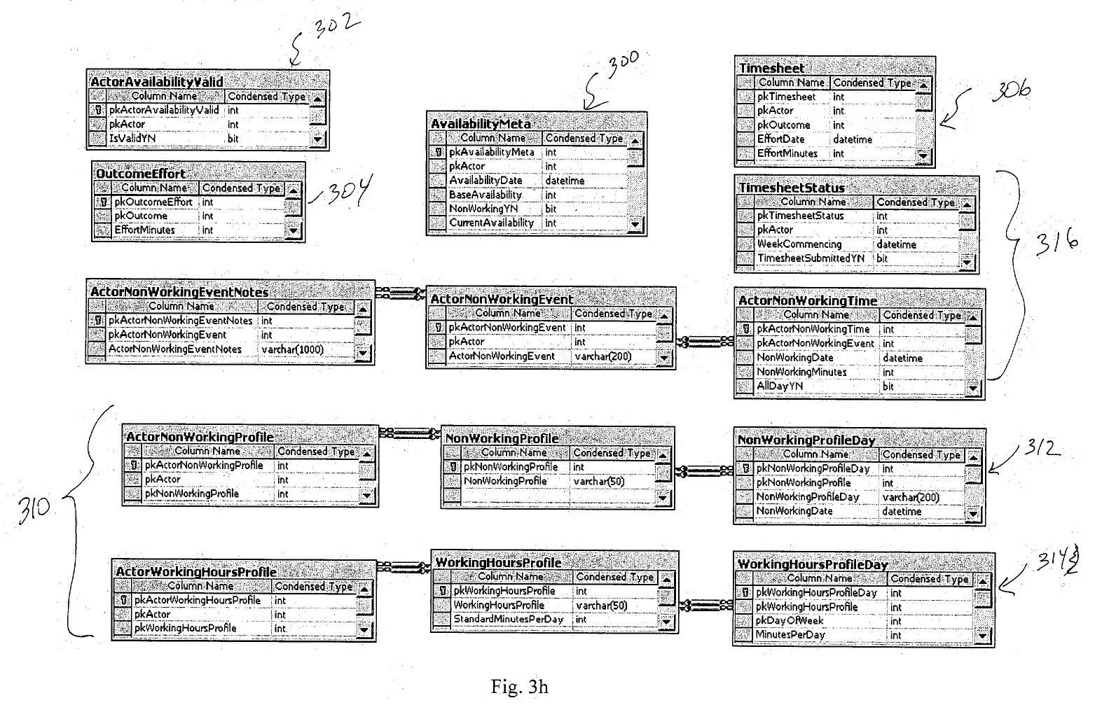

With reference now to the figures and in particular to FIG. 1, therein is shown a system, denoted generally as 10, for managing an organization's resources available to work on a specific objective of the organization according to the invention. As shown, system 10 includes a database 20 which includes fields arranged in an organization specific structure for storing, among other things, various parameters related to the organization, its resources, objectives, projects and outcomes as described herein. For example, the database 20 can be used to store the name of contributors to the organization such as, for example, the users which would access system 10. In this case, a user identifier could be stored within the database 20 at a particular field using database techniques well known in the art. Database 20 could also store a particular objective of the organization such as, for example, a milestone or a particular goal which the organization desires to achieve. In addition, the database 20 could be used to store one or more projects necessary to achieve such objectives as well as the necessary outcomes which must be performed in order to achieve these projects. The specific nature and content of the database 20 and the fields used to store such objectives, projects and outcomes will depend on the nature of the organization and the objectives thereof. FIGS. 3a-3h illustrate one sample database structure which has been devised according to one specific embodiment.

As shown, the database 20 is accessible by a plurality of processes 22 which provide the functionality and processing logic of the system 10 as described herein. Such processes can take the form of application specific software stored on a computerized network of the type readily available in industry. If so, the computerized network could take the form of a distributed processing platform such as a local area network, wide area network and other network topologies well known in the arts. The invention specifically contemplates the system 10 and database 20 being web-enabled for operative access (wired or wireless) over the Internet, a company Intranet or other IP-based networking platform.

A software implemented program product configured to operate as described herein would provide the processing logic and include the various routines and algorithms necessary to carry out the functionality of a system 10 according to the invention. As shown, processes 22 form a bridge between users 24, groups 26, and project 28 functions, and database 20. In this way, users functions 24 and groups functions 26 can access the database 20. Processes 22 work in conjunction with project functions 28 which are stored in database 20 which, in turn, can support the collaborative interaction of contributors (employees, workers, users, etc . . . ) of the organization as well as groups of users, with each other based on the organization specific content stored in database 20.

Specific functions 30 supported by system 10 are shown, and by way of example illustrated as a limited subset of all the various functions which processes 22 must support. For example, functions 30 include user set up, scheduling, collaboration, notification, management, and user interface. Thus, on a broad scale processes 22 collaborate with users functions 24, group functions 26, and project functions 28 in order to provide a broad set of collaboration and scheduling processes as will be explained below.

FIG. 1 shows that users functions 24 can accesses by individual users 32 with one user designated as a project manager 34. Another user can comprises an executive 36. In one embodiment, the information delivered by system 10 to user will depend largely on the type of user accessing the system. For example, a project manager 34 may receive notifications and issues relative to one or more projects over which the project manager 34 has responsibility. Likewise, executive 36 may only want to monitor the activities of other users 32 and/or the project manager 34 on a broad basis leaving the details of any particular project to the users 32 and project manager 36. If so, the notices generated for the executive would be different than those received by either the users 32 or project manager 34.

It should be understood that a system, such as system 10, should not be limited to any particular user types as the invention contemplates a system supporting more than one user type depending on the organization which allows collaboration through processes 22 among users. This is an essential feature of the system 10 as detailed herein. In particular, as indicated by arrows 40, 42 and 44, the system 10 of the invention provides a way for users to interact with each other relying on the information contained in database 20 through processes 22. Likewise, arrow 44 indicates that user functions 24 allow the collaboration with a group of users (typically all users assigned to the same project) via group functions 26. In this way, the system 10 allows the exchange of messages amongst the users and groups of users relative to ongoing projects 28. The exchange of such message will hereby be referred to as collaboration.

Since user functions 24 are accessible by multiple class of users, each user type can be privy to the collaboration process supported by the system 10. This way the system 10 provides a means for individual users or groups of users 32 to exchange ongoing information with each other relative to the status and progress of efforts toward specific outcomes stored in the database for fulfillment of projects 28. As project manager 34 is a user 24, he or she can also engage in collaboration thereby being able to monitor the status and progress of projects 28 as defined by the organization and stored in database 20. In general, a project manager 34 is someone within the organization whose responsibilities include overseeing the status of a particular project. Another class of user, the executive 36, is generally a less sophisticated user who is only interested in the overall progress of a company's objectives. Thus, the processes 24 include collaborative and scheduling processing logic 25 that allows users to be associated with one or more groups which support the projects 28 and which allow users to communicate with each other relative to the status of specific outcomes assigned to them for achieving the projects 28.

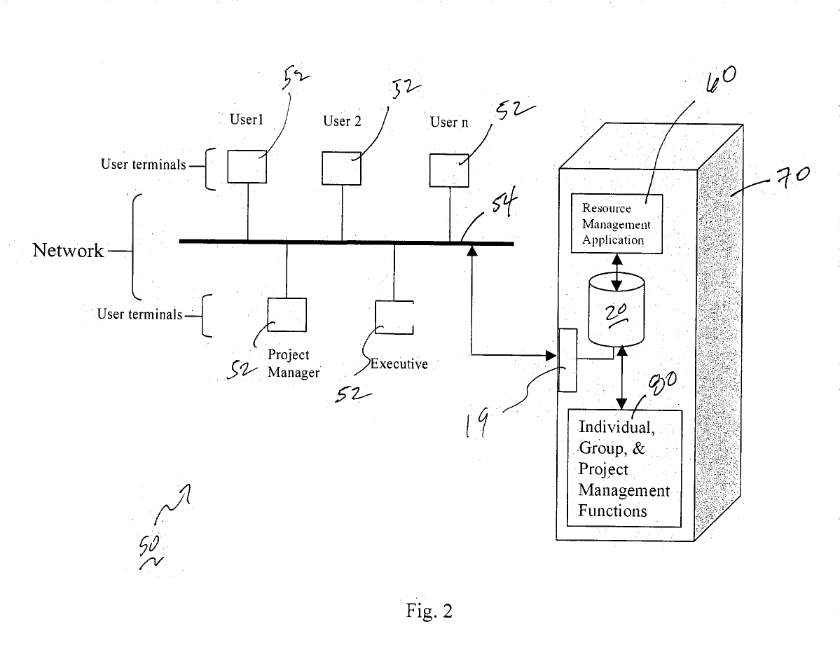

With reference now to FIG. 2, therein is shown a simplified block diagram of a network, denoted generally as 50, wherein the system for managing an organization's resources according to the invention can be implemented. As shown, network 50 includes a plurality of user terminals 52 which provide access to the various users of the network 50 to resource management application 60 which as shown is stored on server 70. It should be understood that the resource management application 60 can be configured in different configurations and that the use of one particular topology over another is left to the discretion of the network or system administrator. The resource management application 60 comprises a software implement program product that, as shown, is communicably coupled to database 20 which as shown is likewise coupled to the individual, group, and project management functions 80 which comprise the functions described above with respect to elements 24, 26, and 28.

Network 50 also comprises a network backbone 54 providing access by users to server 70 housing the resource management application 60 via user terminals 52. As shown, user terminals 52 provide ways for individual users including a project manager and executive, for example, to access the functionality of the resource management application 60. Since the number of terminals can be small or large to accommodate varying types of the organizations and their infrastructure, the present application provides a way for all users within the organization to collaborate as to the status and progress of projects and outcomes thereby providing an efficient outcome driven project management system.

The present invention suggests the use of a database, such as database 20, wherein all the information about an organization is stored and utilized in order to define an organization's objective, project or projects necessary to achieve an objective, and the outcomes required in order to complete such project or projects. In this regard, the resources of the organization can be thought of as its employees including their skills, time available to work on projects, and any other attributes relative to an organization's users. In the following descriptions, a user is referred to as an actor which shall be used interchangeably with the terms “user”, “contributors”, and/or “resource”, unless otherwise indicated.

With reference to FIGS. 3a-3h, therein illustrated a database structure suitable for use with a resource management application (RMA), such as RMA 60, according to the invention. Specifically, in FIG. 3a the structure for various fields, denoted as 100, associated with an actor are illustrated including their interrelationships. Actor fields 100 includes such fields as the actor name 102, actor password 104, actor phone 106, actor email 108, actor detail 110, actor password setting 112, all of which are related to an actor's profile field 114. In this way, the various details of company users (such as their employees) can be stored and utilized by the system 10 in order to permit the affiliation of a user to a specific project as well as specific outcomes associated with the project and communications with other users.

Typically, the information in fields 100 would be entered by a project manager or system administrator during a setup phase of the organization within software embodying the resource management application 60. Since basic information such as name, phone number and email of the user are stored by the system, other users of the system will have access to such information. Likewise, the specific details of a particular actor, field 110, can be described so that users on the system will have knowledge of an employee's ability, skills, work available and schedule. It should be understood that more or less actor fields may be included in a particular organization all within the scope of the invention.

FIG. 3b shows that specific outcomes necessary to achieve a project can be associated with an actor and stored within a database structure of the organization. Specifically, an actor outcome field 120 can be defined which associates an outcome to a user of the organization. The progress made by a user with respect to any particular outcome is also maintained in an actor outcome progress field 122 thereby allowing the progress and status of an outcome to be stored and made available to other users of the system. In this way, the progress and/or status of a particular outcome can be maintained and shared with other users. Likewise, actor outcome effort fields 124, 126 and 128 provide a mechanism for storing various variables relative to a user's effort with respect to a particular outcome. Thus, the responsibilities for an actor with respect to a specific outcome can be defined, stored, and documented.

Finally, the schedule assigned to a particular actor for fulfillment of an outcome can be maintained in an actor outcome timeline field 130 such that all users of the system are made aware of what schedule or timeline has been defined for the achievement of a particular outcome by the particular actor. The actor outcome fields of FIG. 3b are related to the collaboration and scheduling logic 25 within a resource management application, such as RMA 60.

Turning to FIG. 3c, therein is illustrated the relationship between a project and the outcomes necessary to complete the project via project outcome fields 149. Specifically, a project baseline field 150 can be defined and used to track the schedule which has been assigned to a particular project typically by a project manager or an executive utilizing the RMA 60. As shown, a master baseline field 152 is maintained by the system and provides a way of storing a schedule for all projects necessary to achieve a specific objective of the organization. For any particular outcome (as maintained in outcome field 160), a baseline is defined and stored in outcome baseline field 162 such that the schedule defined for the fulfillment of a particular outcome is related and checked against the master baseline field 152 to insure there are no conflicts. In this way, fields 149 provide a mechanism to maintain integrity throughout the system such that no conflicts exist between scheduling of projects, defined outcomes for completing such projects, and the available resources to work on such outcomes.

Project current baseline field 162 and project scene field 164, are related to the baseline field 152 as well as to outcome fields 160 and 162 by the relationships illustrated through connector lines 165. It should be understood that other ways of storing and relating objective schedules to project and outcome schedules can be devised and utilized as long as the data is maintained and related such as conflicts between different outcomes and projects of the organization can be avoided.

FIG. 3d shows an assortment of others fields which are used to maintain various system variables such as, for example, the day of the week field 170, the date format field 172, phone type field 180, help index field 190. These variables can be used by the system to maintain preferences of a particular user as well as other user-related variables such as the status of an outcome or project on which the user is working, field 200, and the type of outcome to which a user is assigned, field 202. An outcome flag field 174 is also provided which can be used to provide a notification to a user of when, for example, a particular outcome or project is at risk or where an issue has arisen, for the purpose of notifying users. In one embodiment, such notifications are provided when a user signs in (or “logs on”) a user terminal. Other system variables as illustrated in FIG. 3d can also be maintained depending on system configuration and the extent of collaboration and scheduling afforded users of the system within a particular organization.

FIG. 3e illustrates a number of custom fields which can be maintained and used in order to customize features of a resource management application according to the invention. As shown, a primary custom field 210 is provided and related to a number of other custom variable fields such as the custom field number 212, the custom field list 214, the custom field type 216, and a custom field string 218. These fields can be used, for example, to store user and/or group preferences. As with many of the system variables defined and utilized by a resource management application according to the invention, more or less custom fields may be defined and utilized in any particular implementation of such an application.

FIG. 3f shows the use of a plurality of outcome fields 229 which help define and track relationships between outcomes. A primary outcome field 230 is used with related fields of outcome directory 232, outcome relate field 234, outcome timeline 236, and outcome detail 238. In this way, a project manager, typically with the assistance and collaboration of other users within the organization, can define an outcome (outcome field 230) and how it relates to other outcomes (outcome dependency 232 and outcome relate field 234) as well as a schedule for achieving an outcome (outcome timeline field 236) and any necessary details (outcome detail 238) at the lowest level and as a tangible result of the organization. The field variables can be modified by a project manager at any time based on his or her monitoring of the status of progress of efforts toward a particular outcome in terms of assigned users to an outcome and progress they are making toward its fulfillment. Also, since users of the system share in the data for outcomes to which they are assigned, users can collaborate with each other and determine the status of a particular outcome from a single unified platform via the data stored in outcome fields 229.

FIG. 3g illustrates field structures for storing data defining a group or unit of the organization and how it relates to specific objectives of the organization. In particular, unit field 260 stores a primary working unit of the organization and is related to its primary mission in unit mission field 262. Likewise, actors associated to the unit can be maintained in unit actor field 270 such that any particular user of the system can be reminded of a group's primary mission (via unit mission field 262) and the details of the unit (unit field 260 and unit detail field 264). By providing a relationship between a unit of the organization, its missions and the users assigned and comprising a unit, a user sees how his or her group fits into the overall objectives of an organization and is able to give perspective to his or her efforts within the organization.

The relationship suggested and defined by the field of FIG. 3g provide a significant advantage over prior art project management systems which gave no indication as to how a particular user fits within the primary objectives of the organization nor his relationship to other users and the projects and/or outcomes on which other users are working. As shown, unit objective field 272 as provided tying in a user (unit actor field 270) to a specified objective of the organization (unit objective field 262) and the relationship of the unit to the organization (unit relate field 264).

As such, a resource management application, such as RMA 60, provides a way for assigning available resources of the organization to specific objectives, projects and outcomes of the organization thereby allowing a mechanism for tracking the efficiency of the resources toward the completion of outcomes and, in turn, projects. Specifically, the resources of the organization comprise the users available to work on specific outcomes, the time they are available to work, and the skills they bring to the organization. FIG. 3h shows a number of fields that can be used for storing the details of available resources of an organization.

For each individual user, entries are made in availability meta field 300 which indicates the availability of a user to work on a given project. An actor availability valid field 302 is also provided and used to verify that a user of the organization is available for work. The effort being put by a user into a particular outcome is tracked and maintained by outcome effort field 304 and a time sheet in terms of the time being put by the user into all outcomes for all projects to which the user is assigned is maintained in time sheet field 306. In this way, a project manager wanting to assign users to specific projects and specific outcomes can gauge the availability of a user and the amount of time that user is putting in on any particular outcome as well as for all outcomes of all projects to which the user is assigned.

Also shown in FIG. 3h, is a plurality of working profile fields, denoted generally as 310, that are included for a particular user to indicate the number of hours which a user (or contributor) of the organization is available to work including non-working days (non-working profile day 312), working days (working hours profile day field 314), and other variables as illustrated by FIG. 3h. Fields tracking a user's working time schedule 316 are also indicated and used to store available time resources for all users of the organization. By maintaining the resources of an organization in terms of a user's availability, his or her time and his or her working days and hours, a project manager is able to efficiently balance and utilize all resources of the organization toward the achievement of specific outcomes related to specific projects of the organization.

Compared to prior art project management'systems which rely solely on the tracking of assignment of tasks assigned to individuals without any indication as to how an individual is using his or her time or an individual's involvement in other activities or projects of the organization, the present invention provides a system that collaborates all organization resources and allows the assignment of resources in a way that substantially reduces conflict within the organization.

Therefore, a database, such as database 20, incorporating the structure illustrated by FIGS. 3a-3h provide a means of defining objectives of the organization (with an “objective” comprising the highest level goal or mission of the organization) and the projects that need to be completed in order to fulfill a defined objective. Projects can be defined and stored within the database structure with specific outcomes which must be realized in order to achieve a particular project likewise detailed and stored in the database. In this sense, an “outcome” is the lowest level tangible result to which manpower can be assigned. Once the data entries within a database'storing the organization's objectives, projects, outcomes, and available resources is created, a user is assigned specific projects and/or outcomes based on skills, availability, and the lack of conflicts as well as how a particular user fits into the overall objectives and projects of the organization. Therefore, a resource management application, such as RMA 60, provides a way of directing desired outcomes of a business organization and linking the organization's objectives to the projects which will achieve these outcomes. In this way, the resource management application of the present invention provides a way to span an organization from top to bottom by providing a tool for managing people, projects and the processes that unit them.

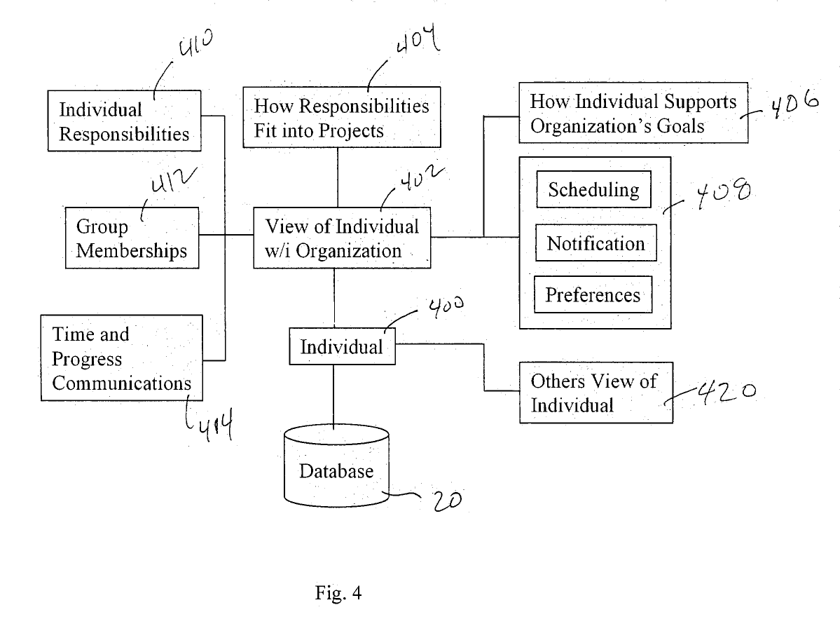

One aspect of the invention is that it provides a plurality of individual functions which a user can utilize as he or she works on assigned outcomes and projects of the organization. With reference to FIG. 4, a block diagram illustrating individual functions is shown and denoted generally by box 400. The individual functions 400 break out into other functions which can be organized and made available to a user on, for example, a user terminal coupled to the RMA 60. The RMA 60 can be configured to display a view of the individual within the organization (box 402) with view (box 402) indicating the individual's position within the hierarchy of the organization. Additionally, the RMA 60 can generate a view of how the individual's responsibility fits into projects of the organization (box 404), as well as a view indicating how the individual supports the organization's goal (box 406), can be provided including personal scheduling notifications and preferences (box 408).

Once outcomes and projects have been assigned to a user, the user's individual responsibilities are readily accessible as indicated (box 410) as well as the group memberships to which the individual has been assigned (box 412) and functions that allow a user to communicate time and progress (box 414) devoted toward the fulfillment of organizational outcomes and projects. As indicated by FIG. 4, another individual function would be a view how the individual fits into the organization from the perspective of other users of the RMA 60 (box 420). Thus, not only does an individual understand how his or her activities fit into the overall view of the organization, but the same information is made available to other users.

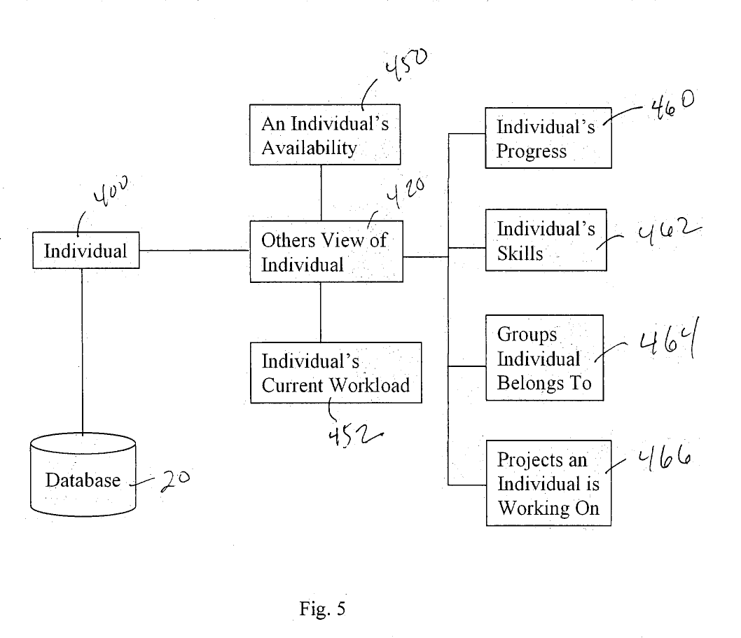

As mentioned above, another aspect of the invention is the ability to track the progress and status of an individual and his current workload. These individual progress functions are better illustrated in FIG. 5 which is a block diagram illustrating an individual's availability (box 450) is maintained and made available to users by RMA 60 as well as an individual's current workload (box 452). As a subset of the other's view of an individual (box 420), a project manager or other user of the system can determine an individual's progress (box 460), an individual's skills (box 462), the groups to which an individual belongs (box 464), and the specific projects an individual is working on (box 466). In this way, the RMA 60 of the present invention provides a way for all users to understand how other users fit into the organization, what projects they are working on, and whether or not they are available.

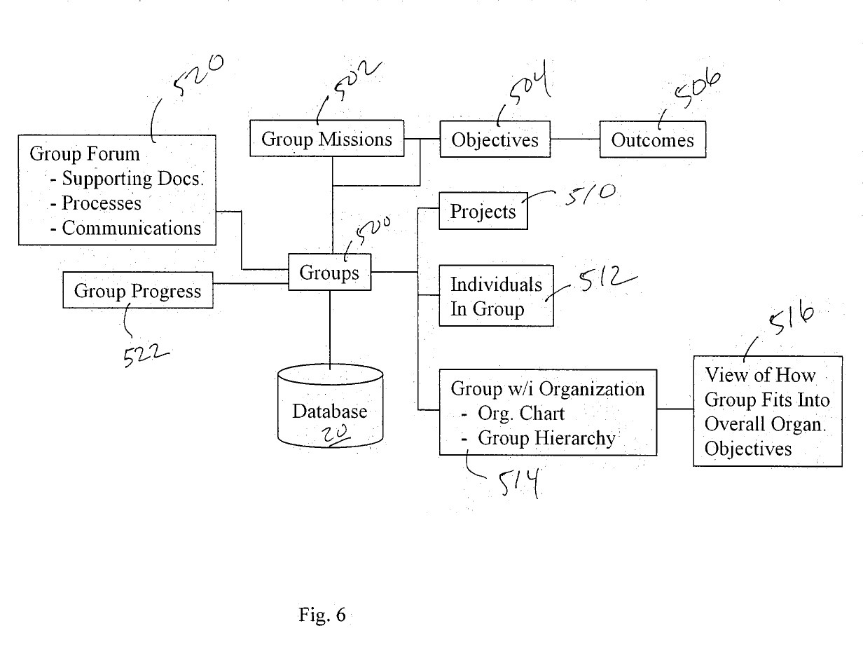

Referring now to FIG. 6, therein is illustrated in a block diagram for a plurality of group functions (box 500), which provide information for a collection of users which have been organized into a group for the purposes of working on projects and/or outcomes associated with organization objectives. Group missions (box 502), are defined and used to guide the directives and policies of the group including their objectives (box 504), and specific outcomes associated with the objectives (box 506).

As shown, a relationship between the group functions (box 500) and the projects assigned to a group (box 510) exists as well as the individuals in a particular group (box 512). Since the project manager maintains control overall individuals and groups, the individuals in a particular group can be altered and modified to suit the current needs of the organization. Group details, such as the organizational chart and group hierarchy, are stored and made available (box 514), which can also lead to a view of how a group fits into overall organizational objectives (box 516).

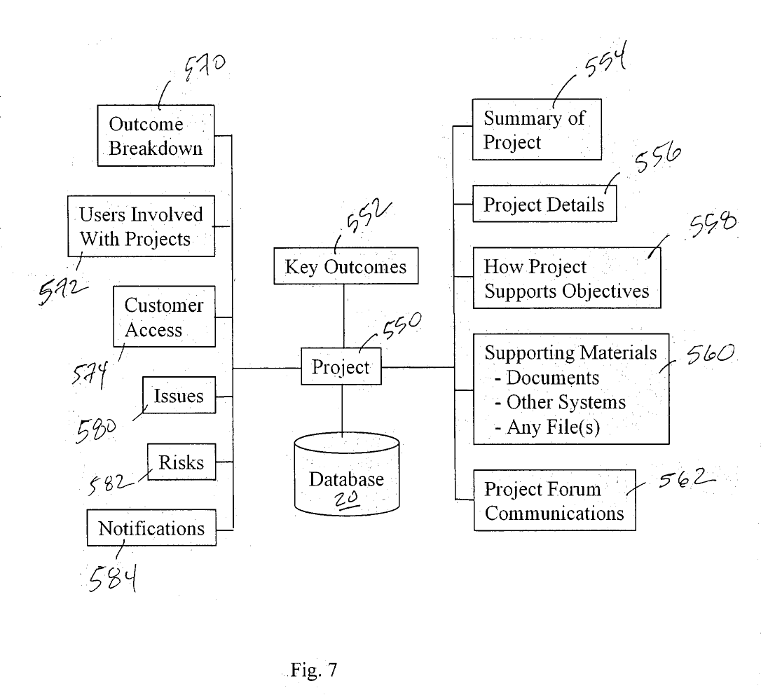

Other group functions include a group forum (box 520) which includes, among other possibilities, any supporting documentation of the group, any processes specific to the group, and the ability for a group to communicate with each other relative the status and progress of efforts toward outcomes, projects, and objectives of the group. Also, the progress made by a group can be stored and displayed in a group progress function (box 522). It should be understood that FIGS. 4, 5, and 6 provide broad level view of general functions which can be implemented in a software implemented program product (i.e. software application) that would provide the appropriate function and generate an output for an individual users and groups of users as appropriate to the prescribed function. Until the present invention no known way of dividing organizational functions by individuals and groups in a way that allowed users to collaborate with each other relative to user and group activities was known or generally available. Another component of the present invention is the implementation of a wide assortment of project functions as illustrated in FIG. 7.

FIG. 7 shows that project functions (box 550) can include a designation of key outcomes, box 552 necessary for the achievement of a given project. For any individual project a summary (box 554), is provided along with project details (box 556). Since users and groups can be associated to a particular project the same entities have readily available the information relative to the project including details. Likewise users can readily discern how a project supports an organization's objectives (box 558) and obtain any supporting materials including documents, access to other systems, and any files necessary to support a project (box 560). Also, communications among users associated with a project is provided through a project form communications function (box 562).

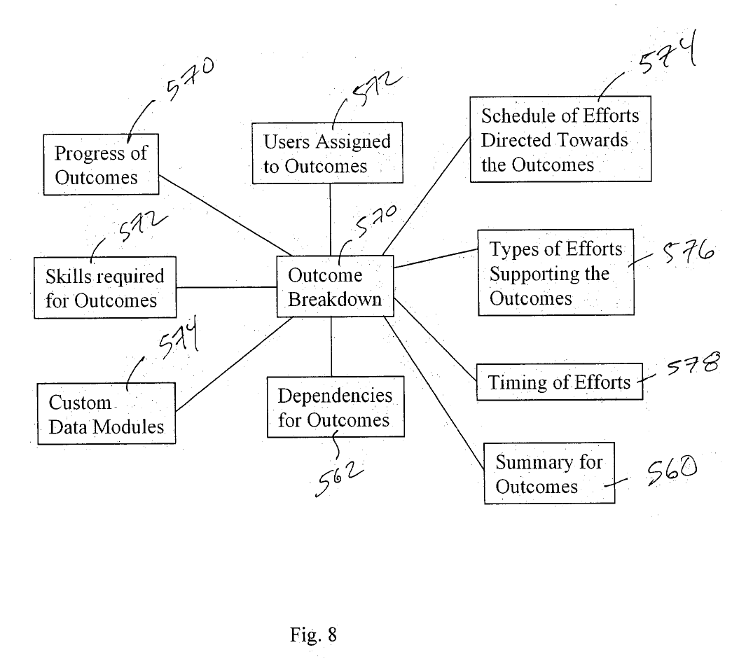

With reference to FIG. 8, other project functions include a breakdown of its outcomes (box 570) as well as the users involved with particular projects (box 572). Should an organization choose to allow customer access to ongoing projects (as indicated in box 574) the customer would be able to track the status of projects and determine what users and user resources have been devoted to the project.

Likewise any issues (box 580) and risks (box 582) associated with a project or that may jeopardize completion of the project can be identified with notifications transmitted to users assigned to the project (box 584). It is contemplated that notifications would be presented to a user upon sign-in to the system which would, in turn, allow a user to respond to a notice by sending a message to other users or groups. In this regard, an exchange of threaded messages can be utilized for collaborative communications among users allowing known issues to be converted to outcomes should the issue rise to the level of a risk to the project. If so, a project manager can decide whether to escalate an issue into a specific outcome to which organizational resources are assigned or simply manage the issue as a known risk.

The decision to raise an issue to an outcome is facilitated by the exchange of messages between users and groups of users that enhances the decision making process of the organization. In this way, a project manager can communicate with other users of the system and engage in research relative to issues identified by users in order to determine whether an issue creates a risk whose resolution must be elevated to outcome status or one which can be managed in the ordinary course of the organization.

FIG. 8 further illustrates the breakdown of outcomes (box 570) according to one embodiment. Specifically users assigned to outcomes are identified (box 572) such that a project manager, for example, can track whether resources have been committed to the fulfillment of a specific outcome. Likewise from the outcome breakdown (box 570) schedule of efforts directed towards outcomes can be generated (box 574) as well as the type of efforts supporting the outcomes (box 576). In order to avoid conflicts the timing of efforts committed to an outcome (box 578) is generated and displayed as well as a summary for all outcomes (box 560) associated with a given project. The dependancy of outcomes one to another (box 562) is further illustrated through all progress of efforts toward outcomes (box 570), skills required for an outcome (box 572), and any custom data modules that may be required (box 574) to support the activities associated with a specified outcome.

Thus, the RMA 60 of the present invention provides a system for relating users, groups, projects and associated outcomes to each other in a way that issues and risks can be identified and managed on a collaborative basis via communications among users and groups of users. Any issues which jeopardize or create risks for the completion of projects can be escalated to an outcome to which resources can be assigned by the project manager. As an assignment of resources will tend to affect the overall scheduling of a project, the system of the present invention provides a collaboration and scheduling processes 25 that automatically checks for conflicts and updates a project schedule. Until the present invention no such way of collaborating and scheduling was known to exist.

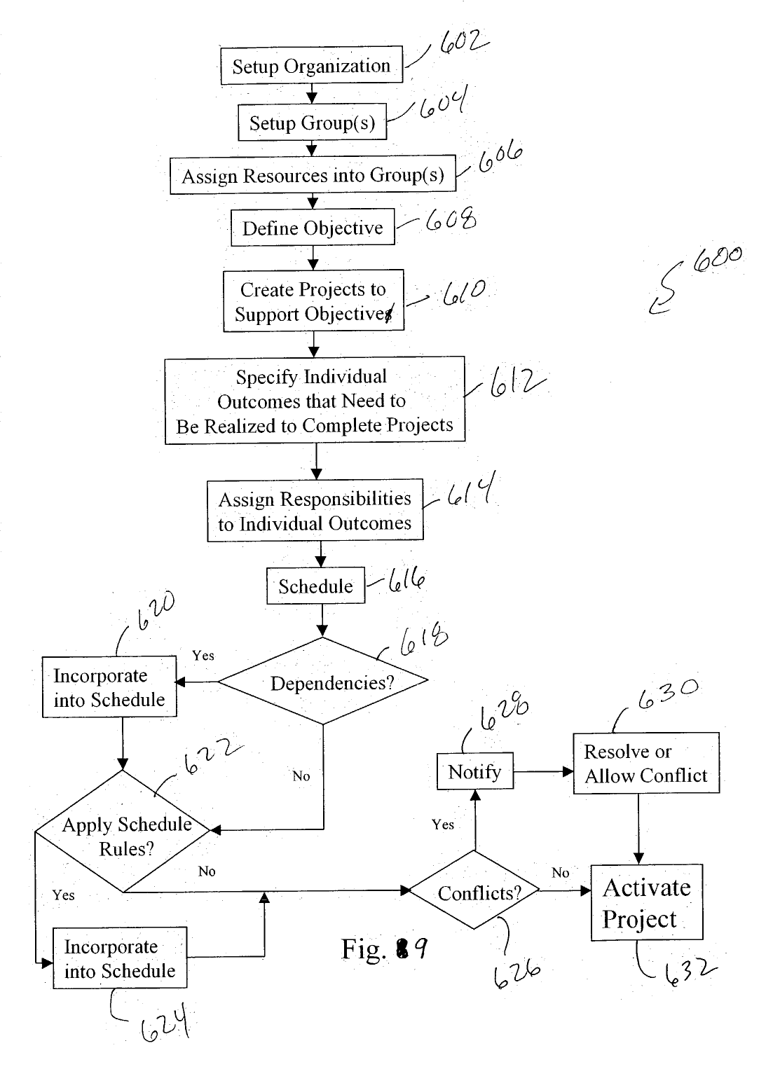

Referring now to FIG. 9, therein is shown a process flow diagram, denoted generally as 600, for the methodology of setting up an organization for using a resource management application, such as RMA 60, according to the invention. Process 600 begins at set-up step 602 wherein the organization is defined including entry of organizational resources such as user, user groups, operational unit of the organization, time available, workdays, etc. . . . Next, at step 604, the available resources are grouped and defined, step 606. For example, for a sale organization, step 606, may consist grouping users according to product type or by operating division or any other way that makes sense for the organization.

Next, a discreet objective of the organization is defined, entered and stored within the system, step 608, with discreet projects necessary to support the objective created and defined, step 610, as best contemplated by the project manager and/or executives of the organization. In essence, steps 608 and 610 force consideration of the broad picture issues facing the organization and the specific project milestones which must be achieved in order to support these objectives. Should the projects necessary to fulfill any objective change, projects can be readily altered, modified or deleted as necessary.

Process 600 continues at step 612 wherein the individual outcomes needed to complete a specific project or projects of the organization are defined and stored within the system. This can be done, for example, by defining and storing outcomes in a database structure of the organization, such as database 20. Next, at step 614, individual responsibilities are assigned to users of the system meaning that an outcome is assigned to a user or group of users thereby focusing the user or group of users on a specific achievable result. In assigning responsibilities at step 614 an outcome project manager can be designated as a responsible user for the outcome or group of outcomes associated with a given project.

At step 616, a preliminary schedule is attached for the achievement of outcomes and their dependancies with other outcomes are determined, step 618, in order to avoid any conflicts. As shown, if dependencies between specific outcomes are identified such dependancies are incorporated into the schedule, step 620. A dependancy in this context could mean the assignment of a single resource to more than one outcome and consideration of its effect on the schedule. Another potential dependancy could be a restriction on proceeding to a second outcome until a first outcome is achieved. In this regard, outcome dependancies can be maintained in a database, such as database 20, within a field, such as outcome dependancy field 232.

If no dependancies are found, process flow is directed to step 622 where any existing scheduling rules may be applied such as, for example, limiting the work week to 40 hours a week or specifying the final deadline for all projects necessary to support a given objective. If schedule rules are determined to exist, they are incorporated into the schedule, step 624. Otherwise process flow is directed step 626 wherein the system checks for any apparent conflicts and notifies the system administrator (project manager, executive, or otherwise) if a conflict is found, step 628, and if so the conflict is either resolved or managed, step 630, and the project is activated, step 632.

In this way, the RMA 60 of the present invention provides a tool for setting up an organization, the objective, projects and outcomes of the organization, and for assigning individuals within the organization the responsibility for working on specified outcomes within a given schedule. Since users, either at the user or group level, collaborate with each other (once the organization has been set-up), the schedule and responsibilities can be altered or modified depending on the progress and status of outcomes related to defined projects.

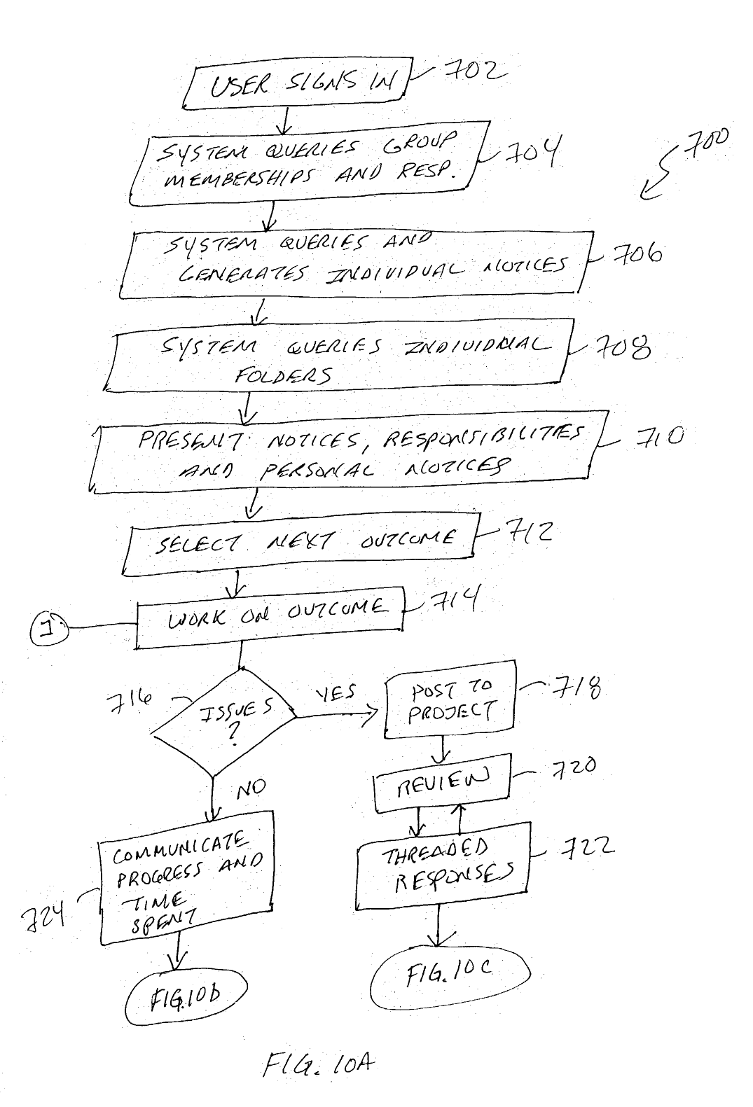

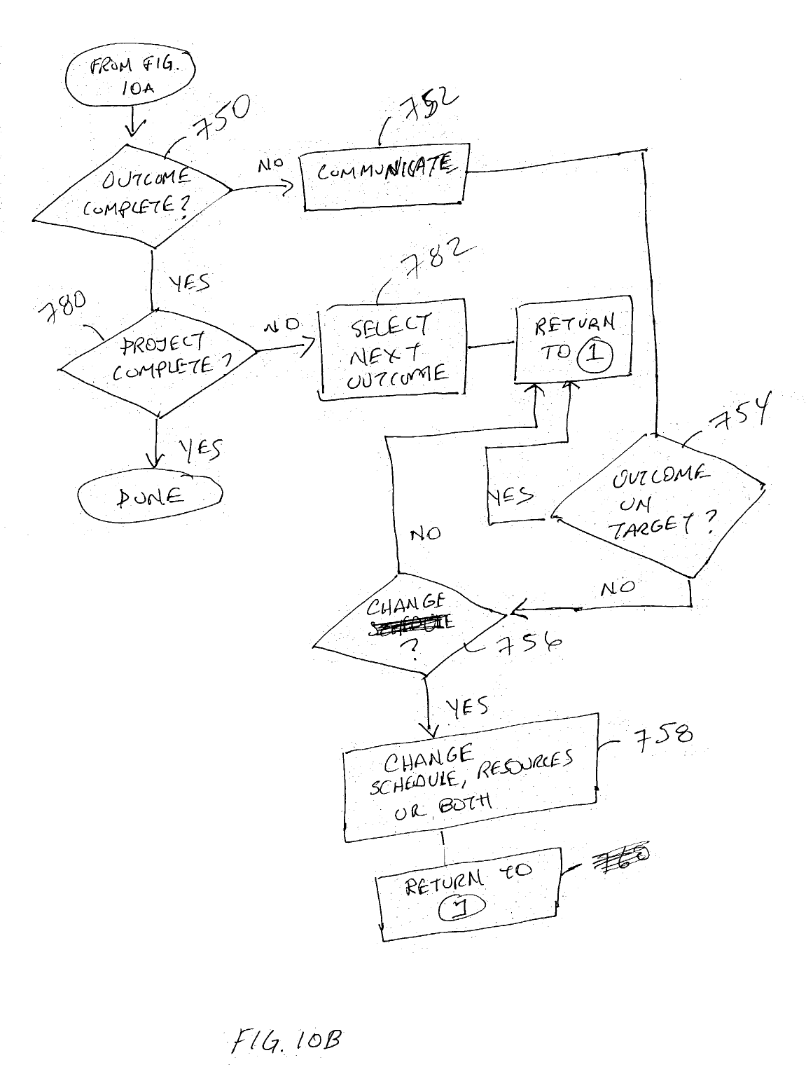

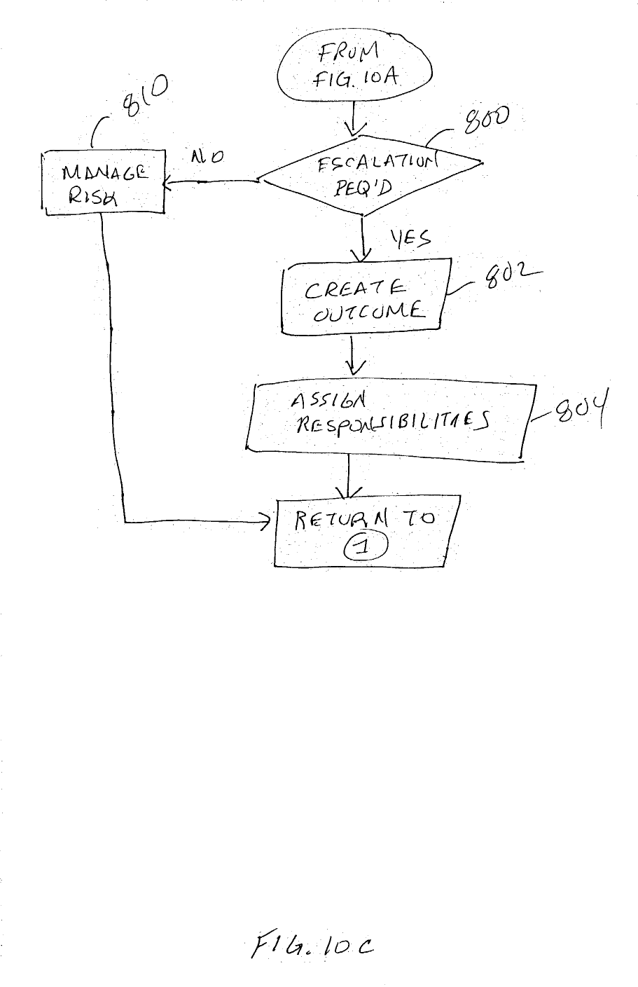

Having described the set-up of an organization reference made to FIGS. 10a, 10b, and 10c which illustrate utilization of a resource management application, such as RMA 60, according to the invention. Specifically, FIG. 10a shows a portion of process, denoted generally as 700, for tracking the progress of efforts toward outcomes at the individual level of an organization.

Typically, process 700 begins when a user signs at step 702 by utilizing a user terminal, such as any one of user terminals 52, in order to access a server, such as server 70, which includes the RMA 60 and database 20. As explained above the RMA 60 presents a plurality of individual, group, and project management functions 80. In this regard the system queries group memberships and responsibilities assigned to a specified user, step 704, and as well as any individual notices for the users, step 706. Next, at 708, the system queries any individual folders which would include personal preferences of the user or any individual files or other communications dedicated for the individual and, at step 710, presents notices, responsibilities and personal notices to the users 710. At this point; the user is presented with a set of outcomes which he or she is working on and, at step 712, the user can select an outcome and work on the outcome, step 714, until the outcome is complete or issues are identified at step 716.

Should issues be revealed at step 716, process flow is directed to step 718 wherein the issues is posted to the project notifying other users within the group or the organization and/or the project manager. The issue can then be placed in review, step 720, by a series of threaded responses between users, step 722, which provides a way for users to collaborate with each other regarding the issue and to determine how to best handle the issue. Handling the issue could result in deciding to manage a risk associated with the issue or the resolution of a particular risk can be elevated to outcome status whereby users are assigned to the outcome and directed to work toward its resolution.

At step 716, if no issues are revealed with respect to this particular outcome process flow is directed to step 724 wherein a user communicates his progress and the time spent working on a particular outcome thereby permitting others within the organization (such as the project manager) to determine how resources within the organization are being used in connection with specific outcomes and related projects. With reference to FIG. 10b, at step 750, a query is made to determine if an outcome is complete and if not process flow is directed to step 752 wherein the user communicates with other users either within his group or in other groups of the organization regarding the status and progress of efforts toward the outcome. As shown in step 754, it is determined if the outcome is on target in terms of the predefined schedule and if so, process flow is directed to step 714 wherein the user assigned to the outcome continues to work on the outcome toward its completion.

If the outcome is not on its target schedule, process flow is directed to step 756 when a decision is made if a change to the schedule assigned to the outcome is necessary and if not work continues on the outcome, step 714, as previously indicated. Otherwise, process flows to step 758 wherein a change is made either to the schedule, the resources assigned to the outcome or both as deemed appropriate by the project manager. Thereafter, process flow is directed to 714 where more work is exerted toward the completion of the outcome.

Going back to step 750, if the outcome is complete a decision is made at step 780 to determine if the project is complete and if not the user is directed at step 782 to select the next outcome. Thereafter, work continues on the next selected outcome in step 714 and the process repeats itself. If a determination at step 780 is made that the project is complete then all outcomes for the selected project have been accomplished and a new project can be assigned or the user can be reassigned to other projects and/or other outcomes associated with other projects.

From FIG. 10a in step 722, process flow is directed to FIG. 10c wherein a decision is made whether a raised issue should be escalated to create another outcome for which resources must be assigned. This is indicated at step 800 wherein a project manager or other responsible user determines if the risk can be managed. If escalation is required process flow is directed to step 802 wherein responsibilities for a new outcome (to deal with the risk) are created and assigned at step 804. Thereafter, work on the new outcome by the user or users assigned continues per step 714. If no escalation is required, as determined at step 800, process flow is directed to step 810 wherein the risk is managed by users of the system without any change in resources or other escalation of the issue.

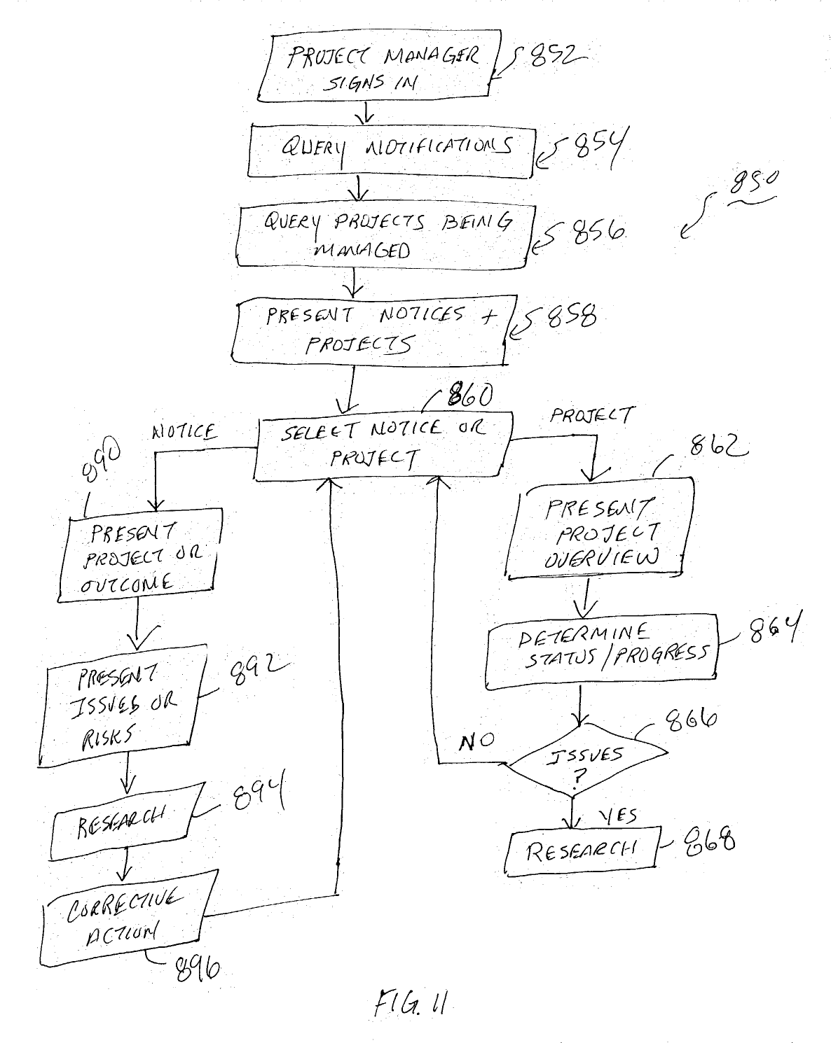

Referring now to FIG. 11, therein is shown the process flow diagram, denoted generally as 850, for the process of utilization of a resource management application, such as RMA 60, by a project manager (or other responsible user of the organization) according to one embodiment of the invention. Typically, use of the resource management application is initiated when a project manager signs in, step 852, and the system queries for any notifications intended for the project manager, step 854. In addition, the system queries to determine what projects are being managed by the project manager, step 856, and then presents notices and projects to the user, step 858, based on the contents of the data maintained in the management application database 20.

At this point, the project manager has been presented with any notices or a list of projects for which he or she is responsible and the project manager can select a notice or project at step 860. Assuming the project manager selects a project, process flow is directed to step 862 wherein the project manager is presented with a project overview indicating the status and progress of a selected project in terms of defined outcomes and the user or users associated with such outcomes. Thus, at step 864, the project manager can determine the status or progress and determine at step 866 if any issues or risks exist that may place a particular project in jeopardy. If so, the project manager can research the issue, step 868, by collaborating with other users assigned to the project or performing other investigations of the issues for which the project manager has received a notice. If not, process flow is directed to step 860 wherein the project manager can select another notice or project.

As indicated from step 860, process flow goes to step 890 wherein the project manager selects a notice resulting in a project or outcome being presented to the project manager associated with the notice. In this sense, a notice can be a message from another user within the organization relative to issues and risks associated to outcomes and/or projects which is typically presented to the project manager at step 892. In this case, project manager can research the issue or assess the risk, step 894, and take corrective action, step 896, as he or she deems appropriate. Next, process flow is redirected back to step 860 wherein the project manager can select the next notice or project to work on.

Accordingly, the present invention discloses a system for managing an organization's resources available to work on a specific objective of the organization with the resources including users arranged into one or more groups and hierarchy designating at least one project manager. The system is adapted to manage resources according to specified projects that must be completed in order to achieve an objective of the organization. The system comprises a plurality of user terminals available for use by users of the organization and a resource management application accessible by the users via the user terminal. According to one embodiment, the resource management application comprises a database for storing projects relating to a specific objective, the outcomes necessary to support these projects and available resources of the organization for working on these projects. The resource management application also includes a plurality of individual group and project management functions operatively coupled to the database and a communications function adapted to facilitate interactions between the individual group and project management functions and users of the terminals. The communications function is generally shown in FIG. 2 as 19.

The system also comprises a network coupling user terminals to the resource management application wherein the resource management application further comprises collaborative and scheduling processing logic that allows users to be associated with one or more groups which support an objective which, in turn, supports projects of the organization. The collaborative and scheduling processing logic further allows users to communicate with each other the status of specific outcomes assigned to them for achieving the projects. The collaborative and scheduling processing logic further allows a project manager to determine the progress of efforts toward an outcome and to modify the schedule associated with the outcome based on its progress.

Also disclosed is a method for managing an organization's resources available to work on an objective of an organization, the resources including users arranged into one or more groups and a hierarchy designating at least one project manager from among the users. The method comprises the steps of organizing an objective of the organization into a plurality of projects and a plurality of outcomes necessary to achieve the projects. Next, the resources of the organization are associated with the plurality of outcomes and an exchange of information on a collaborative basis is performed regarding the status and/or progress of efforts toward outcomes which must be achieved to complete the projects.

The method can also comprise the step of scheduling one or more users to work on a specific outcome based on the amount of time which the one or more users have available. If so, scheduling deadlines are specified for completion of the outcomes and the progress is reported by the users toward the completion of the outcome. The method can also comprise the step of the users and project managers communicating on a collaborative basis with one another.

Also disclosed is a software implanted program product for use on a computer network that facilitates the management of an organization's resources available to work on a specific objective of the organization. The resources include users arranged into one or more groups and a hierarchy with at least one user acting as a project manager. The program product comprises a database for storing one or more projects related to the objective and the outcomes necessary to support said projects and available resources of the organization. The product also includes a plurality of individual group and project functions operatively coupled to the database with communications functions for facilitating interaction between the individual group and project functions and the users by access to the database. The program product also includes collaborative and scheduling processing logic for allowing users associated with one or more groups which support the projects to communicate with each other on a collaborative basis so that users working on a project will be informed as to the status of specific outcomes assigned to them to achieve projects associated with the objective. In one embodiment, the collaborative and scheduling processing logic also allows project manager to determine the status of an outcome and to modify the schedule associated with any particular outcome based on its status.

While the invention has been described with reference to illustrative embodiments, the description is not intended to be construed in a limiting sense. Various modifications and combinations of the illustrated embodiments as well as other embodiments of the invention will be apparent to persons skilled in the art upon reference to this disclosure and to the descriptions provided therein. It is therefore intended that the appended claims encompass any such modifications or embodiments.

What is claimed is:

1. A system for managing an organization's resources available to work on a specific objective of the organization, the resources including users arranged into one or more groups and at least one project manager, the system adapted to manage said resources according to one or more projects that must be completed in order to achieve said specific objective, the system comprising:
a plurality of user terminals available for use by users of said organization;
a resource management application accessible by said users via said user terminals, said resource management application comprising:
a database for storing the one or more projects relating to said specific objective, the outcomes necessary to support said projects, and the available resources of the organization for working on said projects;
a plurality of individual, group and project management functions operably coupled to said database;
a communications function adapted to facilitate interactions between said individual, group and project functions and users of said user terminals; and
a network coupling said user terminals to said resource management application;
wherein said resource management application further comprises collaborative and scheduling processing logic that allows users to be associated with one or more groups which support said projects, and wherein said collaborative and scheduling processing logic further allow users to communicate with each other the status of specific outcomes assigned to them for achieving projects.

2. The system of claim 1 wherein said collaborative and scheduling processing logic further allows said project manager to determine the progress of efforts toward an outcome and to modify the schedule associated with said outcome based on its progress.

3. The system of claim 1 wherein said collaborative and scheduling processing logic further allows said project manager to receive notifications from users relating to the status of specified outcomes.

4. The system of claim 3 wherein said collaborative and scheduling processing logic further allows said project manager to perform any one of the following functions when an outcome is determined to be behind schedule: 1) escalate the outcome in priority, or 2) change the schedule associated with said outcome.

5. The system of claim 3 wherein said collaborative and scheduling processing logic further allows said project manager to send out notifications to a user or users associated with an outcome that is behind schedule.

6. The system of claim 1 wherein said individual functions can generate an individual user interface on at least one of said user terminals notifying a user of his or her responsibilities.

7. The system of claim 6 wherein said individual functions can further generate messages to said user from other users associated with a specified outcome.

8. The system of claim 7 wherein said individual functions can further generate a list of all groups to which an individual belongs.

9. The system of claim 8 wherein said individual functions can further generate a schedule of when certain outcomes associated with a user must be achieved.

10. The system of claim 9.wherein said individual functions can further generate a view of how a user's responsibilities fit into a project of the organization.

11. The system of claim 1 wherein said group functions can generate a group user interface on one or more of said user terminals illustrating the groups of the organization.

12. The system of claim 11 wherein said group functions can further generate a showing of projects on which said groups are working.

13. The system of claim 12 wherein said group functions can further generate a list of objectives associated with said projects.

14. The system of claim 13 wherein said group functions can further generate a list of outcomes necessary to achieve said objectives.

15. The system of claim 14 wherein said group functions support a group forum wherein users can communicate with each other on a collaborative basis.

16. The system of claim 15 wherein said group functions can generate a progress report for projects on which any one of said groups is working.

17. The system of claim 1 wherein said project management functions can generate a list of projects for the organization.

18. The system of claim 17 wherein said project management functions can generate a breakdown of outcomes associated with said projects.

19. The system of claim 18 wherein said project management functions can generate a list of users associated with specific outcomes.

20. The system of claim 19 wherein said project management functions can generate the status of any one of sais users indicating the progress of efforts toward any one of said outcomes.

21. A method for managing an organization's resources available to work on an objective of the organization, the resources including users arranged into one or more groups and a hierarchy designating at least one project manager from among said users, the method comprising the steps of:
defining an objective of the organization as a plurality of projects and a plurality of outcomes necessary to achieve said projects;
associating resources of the organization with said plurality of outcomes;
exchanging information on a collaborative basis regarding the status and/or progress of efforts toward outcomes which must be achieved to complete said projects.

22. The method of claim 21 further comprising the steps of:
scheduling one or more users to work on a specific outcome based on the amount of time which said one or more users have available;
scheduling deadlines for completion of said specific outcome; and
reporting the progress made by said one or more users towards the completion of said specific outcome.

23. The method of claim 22 wherein said reporting step is performed on a collaborative basis between said one or more users and said project manager.

24. The method of claim 23 further comprising the step of the project manager determining if said outcome is on schedule.

25. The method of claim 24 further comprising the step of the project manager escalating said outcome if it is placing completion of a project at risk.

26. The method of 21 further comprising the step of automatically generating notifications to said users and said project manager regarding the status of said outcomes.

27. The method of claim 26 wherein said notifications indicate if a project associated with any of said outcomes is at risk of not being completed.

28. The method of claim 27 further comprising the step of the project manager using a terminal to research the issues associated with said risk and taking corrective action based on the results of said research.

29. The method of claim 28 wherein the project manager engages in one of the following activities when a project is at risk: 1) manage the risk, or 2) escalate the outcome or outcomes creating the risk so that more resources are dedicate to the completion of said outcome or outcomes.

30. A software implemented program product for use by an organization in managing its resources which are available to work on a specific objective of the organization, the resources including users arranged into one or more groups and at least one project manager, the software implemented program product comprising:
a database storing one or more projects related to said specific objective, the outcomes necessary to support said projects, and the available resources of the organization;
a plurality of individual, group and project functions operably coupled to said database;
communications means for facilitating interactions between said individual, group and project functions and said users by access to said database; and
collaborative and scheduling processing logic for allowing allow users associated with one or more groups which support said projects to communicate with each other on a collaborative basis so that users working on a project will be informed as to the status of specific outcomes assigned to them and related to said projects so that when said projects are complete said specific objective is achieved.

31. The program product of claim 30 wherein said collaborative and scheduling processing logic further allows said project manager to determine the status of an outcome and to modify the schedule associated with any particular outcome based on its status.

32. The program product of claim 30 wherein said collaborative and scheduling processing logic created notifications for said users indicating the status of said outcomes.

33. The program product of claim 30 further comprising a user interface generation function for generating output for view by said users on one or more user terminals.

34. The program product of claim 33 wherein said user interface generation function presents users with a sign-in screen for authenticating users of the organization.

35. The program product of claim 34 wherein said user interface generation functions accepts a user ID and based on the user's ID generates a screen showing the group memberships of a specific user.

36. The program products of claim 35 wherein said user interface generation function also shows notifications for said specific user on said screen.

37. The program product of 30 wherein said collaborative and scheduling processing logic supports the exchange of threaded messages between said users.

38. The program product of 30 wherein said collaborative and scheduling processing logic allows said project manager to assign users to specific outcomes.

39. The program product of 38 wherein said collaborative and scheduling processing logic allows said project manager schedule deadlines for completion of outcomes by users assigned to said specific outcomes.

40. The program product of 39 wherein said collaborative and scheduling processing logic allows said project manager to escalate specific outcomes if they present a risk to a project.
